(19) United States
(12) Patent Application Publication
(10) Pub. No.: US 2015/0200741 A1
(43) Pub. Date: Jul. 16, 2015

(54) CONTROL CHANNEL DETECTION METHOD AND USER EQUIPMENT

(71) Applicant: Huawei Technologies Co., Ltd., Shenzhen (CN)

(72) Inventors: Kunpeng Liu, Beijing (CN); Jianqin Liu, Beijing (CN); Jianghua Liu, Beijing (CN)

(21) Appl. No.: 14/668,472

(22) Filed: Mar. 25, 2015

Related U.S. Application Data
(63) Continuation of application No. PCT/CN2012/082100, filed on Sep. 26, 2012.

(51) Int. Cl. H04J 11/00; H04W 72/04; H04W 72/00; H04L 5/00

(52) U.S. Cl. CPC H04J 11/0086; H04L 5/0053; H04L 5/0007; H04W 72/042; H04W 72/005

(57) ABSTRACT

A control channel detection method and user equipment are disclosed. The control channel detection method includes: determining, by a user equipment, a control channel search interval according to a control channel resource set and/or a control channel type; and performing control channel detection in the search interval, where the control channel resource set includes at least one physical resource block. In embodiments of the present invention, the UE can determine an E-PDCCH search interval according to the control channel resource set and/or the control channel type, thereby implementing control channel detection of the UE. In this way, a solution is provided for the scenario in which multiple control channel resource sets are configured by a network side for the UE.

### CROSS-REFERENCE TO RELATED APPLICATIONS

This application is a continuation of International Application No. PCT/CN2012/082100, filed on Sep. 26, 2012, which is hereby incorporated by reference in its entirety.

### TECHNICAL FIELD

The present invention relates to the field of communications technologies, and in particular, to a control channel detection method and user equipment.

### BACKGROUND

In the prior art, a PDCCH (Physical Downlink Control Channel, physical downlink control channel) occupies the first few OFDM (Orthogonal Frequency Division Multiplexing, orthogonal frequency division multiplexing) symbols of a subframe, for example, occupies three OFDM symbols. With CRS (common reference signal, common reference signal) overhead removed from the three OFDM symbols, a resource formed by the remaining REs (Resource Element, resource element) corresponds to the entire search interval of the PDCCH. The entire search interval uses a CCE (control channel element, control channel element) as a minimum granularity, and a UE (User Equipment, user equipment) detects the control channel in the determined search space.

With massive deployment of heterogeneous networks, in the Rel-11, the PDCCH is challenged drastically in terms of capacity, coverage, and interference coordination. The design of an E-PDCCH (Enhanced PDCCH, enhanced physical downlink control channel) is studied and discussed in the 3GPP standard.

For the E-PDCCH, the network side may configure K control channel resource sets (set) for each UE, where K is a positive integer greater than or equal to 1, and each control channel resource set includes at least one physical resource block pair (PRB pair). For example, as shown in FIG. 1, the network side configures three control channel resource sets for the UE, and each control channel resource set includes four PRBs (physical resource block, physical resource block) pairs. For example, control channel resource set 1 includes PRB pairs 1, 4, 7, and 10; control channel resource set 2 includes PRB pairs 2, 5, 8, and 11; control channel resource set 3 includes PRB pairs 3, 6, 9, and 12; and each PRB pair includes four eCCEs (Enhanced-CCE, enhanced control channel element), and therefore, it can be seen that each control channel resource set includes sixteen eCCEs, and eCCEs in each control channel resource set are numbered independently.

However, the prior art does not provide a method for determining a search interval of an E-PDCCH, and therefore, the UE cannot perform control channel detection.

### SUMMARY

Embodiments of the present invention provide a control channel detection method and user equipment, so that the UE can perform control channel detection in an E-PDCCH search interval.

According to a first aspect, a control channel detection method is provided, including:

determining, by a user equipment, a control channel search interval according to a control channel resource set and/or a control channel type, where the control channel resource set includes at least one physical resource block; and

performing control channel detection in the search interval.

According to a second aspect, a control channel transmission method is provided, including:

determining, by a base station, a control channel search interval according to a control channel resource set and/or a control channel type, where the control channel resource set includes at least one physical resource block; and

mapping an enhanced control channel to the search interval and sending the search interval.

According to a third aspect, a user equipment is provided, including:

a determining unit, configured to determine a control channel search interval according to a control channel resource set and/or a control channel type, where the control channel resource set includes at least one physical resource block; and

a detecting unit, configured to perform control channel detection in the search interval determined by the determining unit.

According to a fourth aspect, a base station is provided, including:

a determining module, configured to determine a control channel search interval according to a control channel resource set and/or a control channel type, where the control channel resource set includes at least one physical resource block; and

a transmission module, configured to map an enhanced control channel to the search interval determined by the determining module and send the search interval.

According to a sixth aspect, a user equipment is provided, including a processor, where:

the processor is configured to determine a control channel search interval according to a control channel resource set and/or a control channel type, where the control channel resource set includes at least one physical resource block; and perform control channel detection in the determined search interval.

According to a seventh aspect, a base station is provided, including a transceiver apparatus and a processor, where:

the processor is configured to determine a control channel search interval according to a control channel resource set and/or a control channel type, where the control channel resource set includes at least one physical resource block; and map an enhanced control channel to the determined search interval; and

the transceiver apparatus is configured to send the search interval.

In the embodiments of the present invention, the UE can determine an E-PDCCH search interval according to the control channel resource set and/or the control channel type, thereby implementing control channel detection of the UE. In this way, a solution is provided for the scenario in which multiple control channel resource sets are configured by a network side for the UE.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic diagram of multiple control channel resource sets configured by a network side for a UE;

FIG. 2 is a flowchart of a control channel detection method according to an embodiment of the present invention;

FIG. 3 is a flowchart of a method for determining a search interval according to an embodiment of the present invention;

FIG. 4a is a schematic diagram of different control channel resource sets applied to different subframes in the embodiment shown in FIG. 3;

FIG. 4b is a schematic diagram of different transmission manners of control channel resource sets configured by a higher layer in the embodiment shown in FIG. 3;

FIG. 4c is a schematic diagram of control channel candidates of control channel resource sets configured by a higher layer in the embodiment shown in FIG. 3;

FIG. 5 is a schematic diagram of a first mapping relationship between a second carrier and control channel resource sets on a first carrier in the embodiment shown in FIG. 3;

FIG. 6 is a schematic diagram of a second mapping relationship between the second carrier and the control channel resource sets on the first carrier in the embodiment shown in FIG. 3;

FIG. 7 is a flowchart of a first embodiment of a method for determining a search start point of control channels according to the present invention;

FIG. 8 is a flowchart of a second embodiment of a method for determining a search start point of control channels according to the present invention;

FIG. 9 is a schematic diagram of determining a search start point of control channels in the embodiment shown in FIG. 8;

FIG. 10 is another schematic diagram of determining a search start point of control channels;

FIG. 11 is a flowchart of a third embodiment of a method for determining a search start point of control channels according to the present invention;

FIG. 12 is a schematic diagram showing how multiple UEs determine a search interval in different control channel resource sets by using the same method;

FIG. 13 is a flowchart of a control channel transmission method according to an embodiment of the present invention;

FIG. 14 is a schematic structural diagram of a first embodiment of a user equipment according to the present invention;

FIG. 15 is a schematic structural diagram of a determining unit according to an embodiment of the present invention;

FIG. 16 is a schematic structural diagram of a first embodiment of a start point determining subunit according to the present invention;

FIG. 17 is a schematic structural diagram of a second embodiment of a start point determining subunit according to the present invention;

FIG. 18 is a schematic structural diagram of a third embodiment of a start point determining subunit according to the present invention;

FIG. 19 is a schematic structural diagram of a second embodiment of a user equipment according to the present invention;

FIG. 20 is a schematic structural diagram of a first embodiment of a base station according to the present invention;

FIG. 21 is a schematic structural diagram of a determining module according to an embodiment of the present invention;

FIG. 22 is a schematic structural diagram of a first embodiment of a start point determining submodule according to the present invention;

FIG. 23 is a schematic structural diagram of a second embodiment of a start point determining submodule according to the present invention;

FIG. 24 is a schematic structural diagram of a third embodiment of a start point determining submodule according to the present invention; and

FIG. 25 is a schematic structural diagram of a second embodiment of a base station according to the present invention.

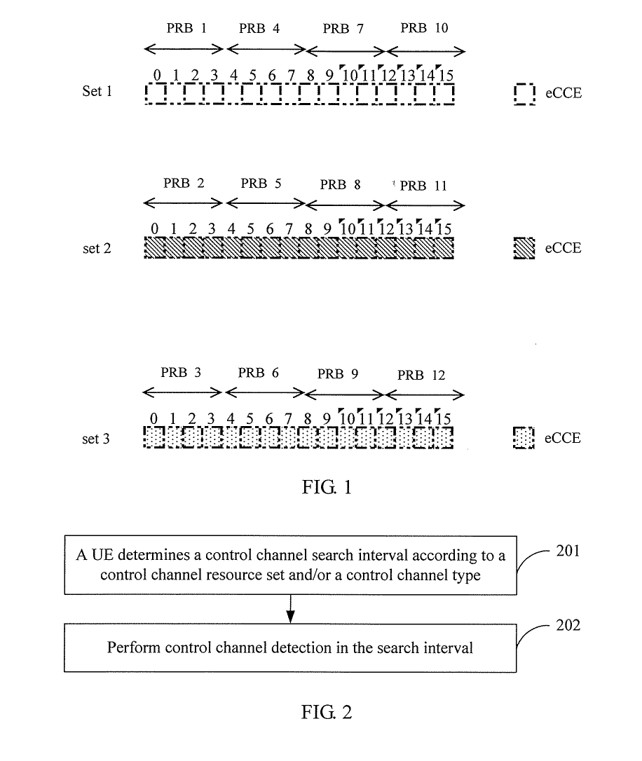

### DETAILED DESCRIPTION

To enable a person skilled in the art to better understand the technical solutions in the embodiments of the present invention and make the above objectives, characteristics, and advantages of the present invention more comprehensible, the following further describes the technical solutions of the present invention in detail with reference to accompanying drawings.

FIG. 2 is a flowchart of a control channel detection method according to an embodiment of the present invention.

The method may include the following steps:

Step 201: A UE determines a control channel search interval according to a control channel resource set and/or a control channel type.

The UE may determine the control channel search interval according to the control channel resource set or the control channel type, or according to both the control channel resource set and the control channel type. The control channel resource set includes at least one physical resource block.

Step 202: Perform control channel detection in the search interval.

In the embodiment of the present invention, the UE can determine an E-PDCCH search interval by determining the control channel according to the control channel resource set and/or the control channel type, thereby implementing control channel detection of the UE. In this way, a solution is provided for the scenario in which multiple control channel resource sets are configured by a network side for the UE.

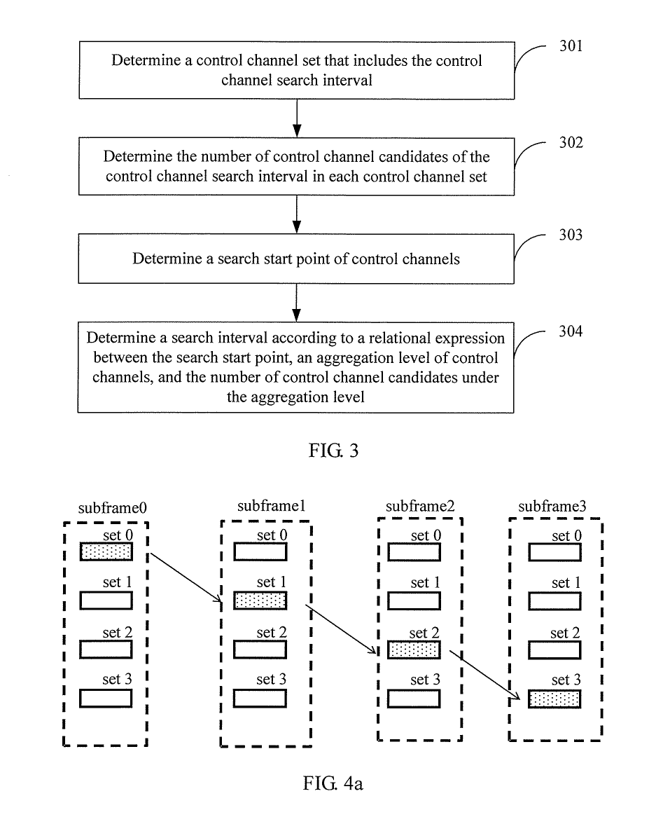

In the embodiment of the present invention, if the granularity of the control channel search interval determined by the UE in step 201 is a search interval within a control channel resource set, the steps shown in FIG. 3 are applicable to the process of determining the search interval no matter whether the UE determines the control channel search interval according to the control channel resource set or the control channel type, or according to both the control channel resource set and the control channel type.

FIG. 3 is a flowchart of a method for determining a search interval according to an embodiment of the present invention.

The method for determining the search interval may include the following steps:

Step 301: Determine a control channel set that includes the control channel search interval.

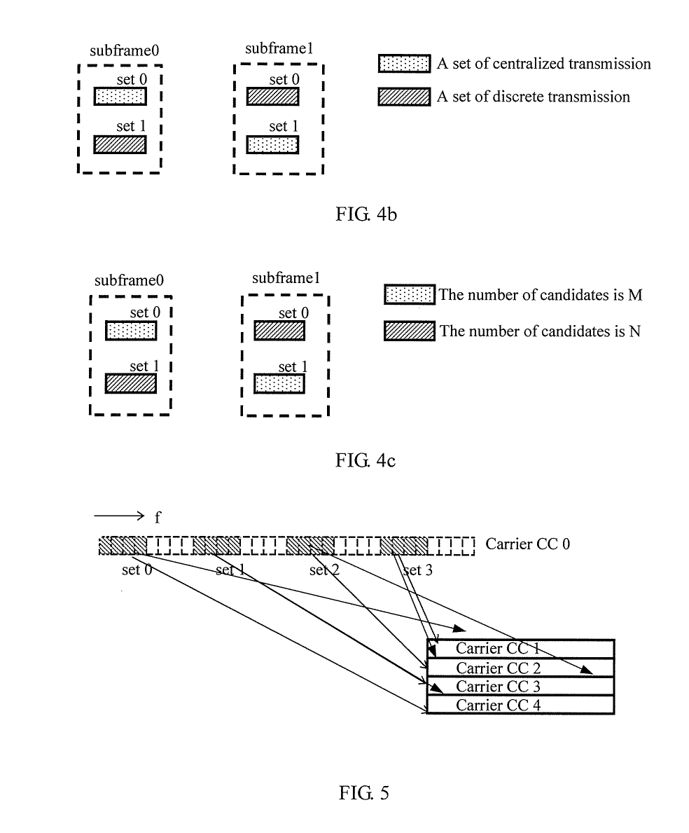

In an embodiment of the present invention, the UE may determine the control channel resource set that includes the control channel search interval according to a function relationship between the control channel resource set and the time. That is, the control channel resource set that includes the control channel search interval varies with time. Different slots (slot) may employ different control channel resource sets, or different subframes employ different control channel resource sets. As shown in FIG. 4a, at subframe 0, the control channel resource set that includes the control channel search interval is set 0; at subframe 1, the control channel resource set that includes the control channel search interval is set 1; at subframe 2, the control channel resource set that includes the control channel search interval is set 2; and, at subframe 3, the control channel resource set that includes the control channel search interval is set 3.

The control channel resource set that includes the control channel search interval of the UE may be a function of time, where the time may be a slot or a subframe or is predefined. Specifically, the control channel resource set that includes the control channel search interval may be determined by using a carrier and/or an RNTI (radio network temporary identifier, radio network temporary identifier) and/or a subframe number. For example, in N control channel resource sets configured by a higher layer, it may be determined, according to the subframe number, that the control channel resource sets that include the control channel search interval of a current subframe are M control channel resource sets among the control channel resource sets configured by the higher layer, where N is a positive integer greater than or equal to 1, M is a positive integer greater than or equal to 1 and less than or equal to N, and the M control channel resource sets in different subframes are the same or different.

As shown in FIG. 4b, set 0 and set 1 are control channel resource sets configured by the higher layer. Within subframe 0, set is a centralized transmission set and set 1 is a discrete transmission set, and therefore, in a next subframe, namely, subframe 1, set 0 is a discrete transmission set and set 1 is a centralized transmission set.

In another embodiment of the present invention, in a multi-carrier scenario, that is, when the UE has configured scheduling of data of multiple second carriers on a first carrier, the determining a control channel set that includes the control channel search interval may also be: determining, according to a mapping relationship between the second carrier and the control channel resource set, a control channel resource set existing on the first carrier and corresponding to the control channel of the second carrier.

The mapping relationship between the second carrier and the control channel resource set may be as follows:

the control channel resource set of the second carrier is a function of an index number of the second carrier; or

a location of the control channel resource set on the first carrier is the same as a location of the control channel resource set on the second carrier.

That the control channel resource set of the second carrier is a function of the index number of the second carrier specifically may be: as shown in FIG. 5, P second carriers are scheduled on the first carrier CC 0, and, on the first carrier CC 0, the control channel resource set of the control channels of the P second carriers is a function of the index number of the P second carriers.

For example, four control channel resource sets, namely, set 0, set 1, set 2, and set 3, are configured on the first carrier CC 0. In practical transmission, PRB pairs in each control channel resource set may be discontinuous and discrete. For ease of illustration, the PRB pairs in each control channel resource set in FIG. 5 are continuous. Assuming that n_{CI} is a sequence number index of each second carrier, the control channel resource set of the control channels of the P second carriers within the search interval on the first carrier CC 0 is a function of n_{CI}. In FIG. 5, it is obtained, according to the function relationship, that, the sequence number index of the second carrier CC 1 corresponds to set 3 and set 0, the sequence number index of the second carrier CC 2 corresponds to set 2 and set 3, the sequence number index of the second carrier CC 3 corresponds to set 1 and set 2, and the sequence number index of the second carrier CC 4 corresponds to set 0 and set 1. Therefore, correspondingly, the control channel of the second carrier CC 1 are detected on set 3 and set 0 on the first carrier CC 0, the control channel of the second carrier CC 2 are detected on set 2 and set 3 on the first carrier CC 0, the control channel of the second carrier CC 3 are detected on set 1 and set 2 on the first carrier CC 0, and the control channel of the second carrier CC 4 are detected on set 0 and set 1 on the first carrier CC 0.

That the location of the control channel resource set on the first carrier is the same as the location of the control channel resource set on the second carrier specifically may be: as shown in FIG. 6, if set 1 is configured on the second carrier CC 1, set 2 is configured on the second carrier CC 2, and set 3 is configured on the second carrier CC 3, when the control channel of the second carrier CC 1 is detected on the first carrier CC 0, the detection is performed in the location existing on the first carrier CC 0 and corresponding to set 1 configured on the second carrier CC 1; when the control channel of the second carrier CC 2 is detected on the first carrier CC 0, the detection is performed in the location existing on the first carrier CC 0 and corresponding to set 2 configured on the second carrier CC 2; and, when the control channel of the second carrier CC 3 is detected on the first carrier CC 0, the detection is performed in the location existing on the first carrier CC 0 and corresponding to set 3 configured on the second carrier CC 3.

Step 302: Determine the number of control channel candidates of the control channel search interval in each control channel set.

The determining the number of control channel candidates specifically may be: determining the number of control channel candidates of the control channel search interval in each control channel set according to a carrier ID (carrier index or identifier) and/or a radio network temporary identifier and/or a subframe number.

For example, as shown in FIG. 4c, set 0 and set 1 are control channel resource sets configured by the higher layer. Within subframe 0, the number of control channel candidates configured in set 0 is M, and the number of control channel candidates configured in set 1 is N, and therefore, within a next subframe, namely, subframe 1, the number of control channel candidates configured in set 0 is N, and the number of control channel candidates configured in set 1 is M; or, within a next subframe, namely, subframe 1, the number of control channel candidates configured in set 0 is X, and the number of control channel candidates configured in set 1 is Y, where X is unequal to N, and Y is unequal to M.

Step 303: Determine a search start point of control channels.

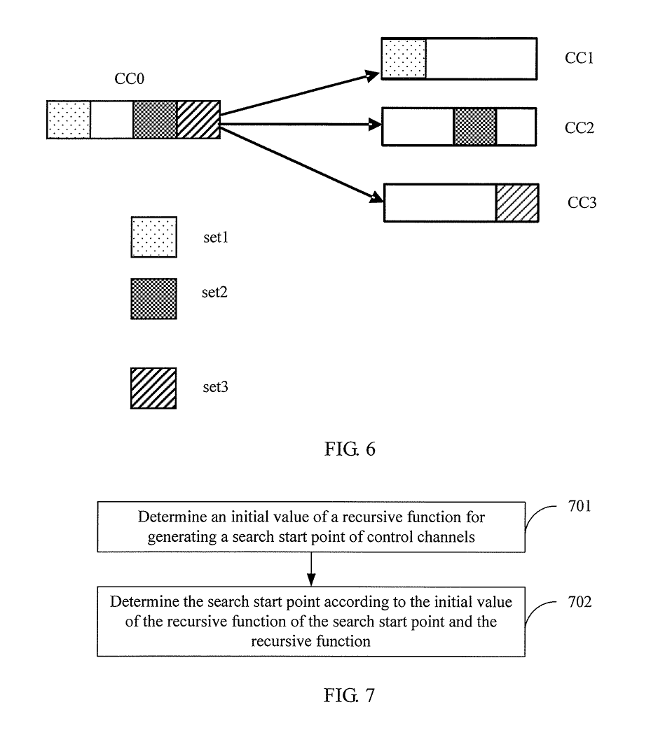

In an embodiment, the process of determining the search start point of control channels may further include the steps shown in FIG. 7. FIG. 7 is a flowchart of a first embodiment of a method for determining a search start point of control channels according to the present invention.

Step 701: Determine an initial value of a recursive function for generating the search start point of control channels.

The initial value of the search start point may be an identifier that can identify the UE, for example, an RNTI allocated by a base station to the UE, denoted by n_{RNTI}. The initial value of the search start point is denoted by Y₋₁, and therefore:

Y₋₁=n_{RNTI}.

However, the initial value may also be another value and is not limited to n_{RNTI}.

Step 702: Determine the search start point according to the initial value of the recursive function of the search start point and the recursive function.

After the initial value of the search start point is obtained, the search start point of the UE in each control channel resource set may be determined according to the initial value and a recursive function, such as a HARSH function.

For example, Yₖ=(A*Yₖ₋₁)mod D, where Yₖ is a search start point of the UE in the control channel resource set, and A and D are constants.

The process of determining the search start point of control channels may also be implemented in other manners.

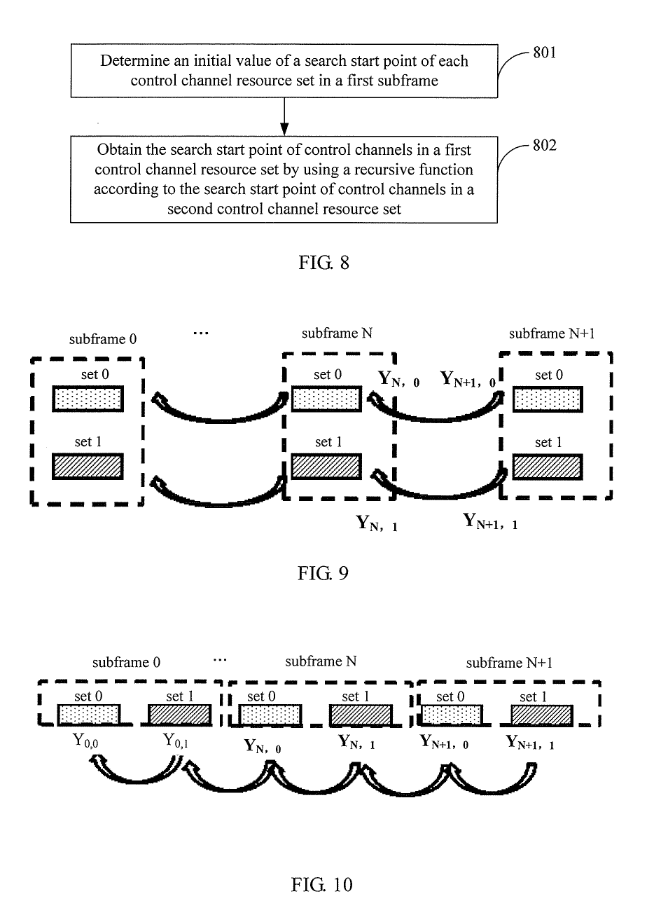

In another embodiment of the present invention, the process of determining a search start point of control channels may also be implemented according to the embodiment shown in FIG. 8.

FIG. 8 is a flowchart of a second embodiment of a method for determining a search start point of control channels according to the present invention.

The method may include the following steps:

Step 801: Determine an initial value of the search start point of each control channel resource set in a first subframe.

As shown in FIG. 9, first, an initial value of the search start point of each control channel resource set in the first subframe needs to be determined. For ease of description, the control channel resource sets in each subframe are numbered. For example, subframe 0 includes two control channel resource sets, so that the control channel resource sets are numbered as set 0 and set 1; and subframe 1 also includes two control channel resource sets, so that the control channel resource sets are also numbered as set 0 and set 1, and so on.

Therefore, in this step, the initial value of the search start point of set 0 and set 1 in subframe 0 needs to be determined first.

Step 802: Obtain the search start point of control channels in a first control channel resource set by using a recursive function according to the search start point of control channels in a second control channel resource set.

A subframe that includes the second control channel resource set is a subframe previous to the subframe that includes the first control channel resource set, and the first control channel resource set and the second control channel resource set are in the same location in their respective subframes.

In the schematic diagram shown in FIG. 9, subframe 0 is previous to subframe 1, and therefore, the search start point of control channels in set 0 in subframe 1 is obtained by using a recursive function according to the search start point of control channels in set 0 in subframe 0, and the search start point of control channels in set 1 in subframe 1 is obtained by using a recursive function according to the search start point of control channels in set 1 in subframe 0. Subframe 2 is previous to subframe 1, and therefore, the search start point of control channels in set 0 in subframe 2 is obtained by using a recursive function according to the search start point of control channels in set 0 in subframe 1, and the search start point of control channels in set 1 in subframe 2 is obtained by using a recursive function according to the search start point of control channels in set 1 in subframe 1, and so on.

In another embodiment, the initial value of the search start point of a specified control channel resource set in the first subframe may be determined first.

As shown in FIG. 10, first, an initial value of the search start point of the first control channel resource set in the first subframe needs to be determined. For ease of description, the control channel resource sets in each subframe are numbered. For example, subframe 0 includes two control channel resource sets, so that the control channel resource sets are numbered as set 0 and set 1; and subframe 1 also includes two control channel resource sets, so that the control channel resource sets are also numbered as set 0 and set 1, and so on.

Therefore, the initial value of the search start point of the first control channel resource set (set 0) in subframe 0 needs to be determined first.

Then, in the control channel resource sets of the subframe, the search start point in one part of control channel resource sets is obtained by using a recursive function according to the search start point in other control channel resource sets in the subframe that includes this part, and the search start point in the other part of control channel resource sets is obtained by using a recursive function according to the search start point in the control channel resource set(s) (one set or multiple sets) in a subframe previous to the subframe that includes the other part.

Specifically, the search start point of control channels in the third control channel resource set may be obtained by using a recursive function according to the search start point of control channels in the fourth second control channel resource set.

The third control channel resource set and the fourth control channel resource set are located in the same subframe, and, in the same subframe, the order of location of the fourth control channel resource set is previous and adjacent to that of the third control channel resource set; or, the fourth control channel resource set is in a subframe previous to the subframe that includes the third control channel resource set, the fourth control channel resource set is the last set in the subframe that includes the fourth control channel resource set, and the third control channel resource set is the first set in the subframe that includes the third control channel resource set.

As shown in FIG. 10, in the same subframe 0, the search start point of control channels in set 1 is obtained by using a recursive function according to the search start point of control channels in set 0; in the same subframe 1, the search start point of control channels inset 1 is obtained by using a recursive function according to the search start point of control channels in set 0, and so on; and, in adjacent subframes, the search start point of control channels in set 0 in subframe 1 is obtained by using a recursive function according to the search start point of control channels in set 1 in subframe 0, and the search start point of control channels in set 0 in subframe 2 is obtained by using a recursive function according to the search start point of control channels in set 1 in subframe 1.

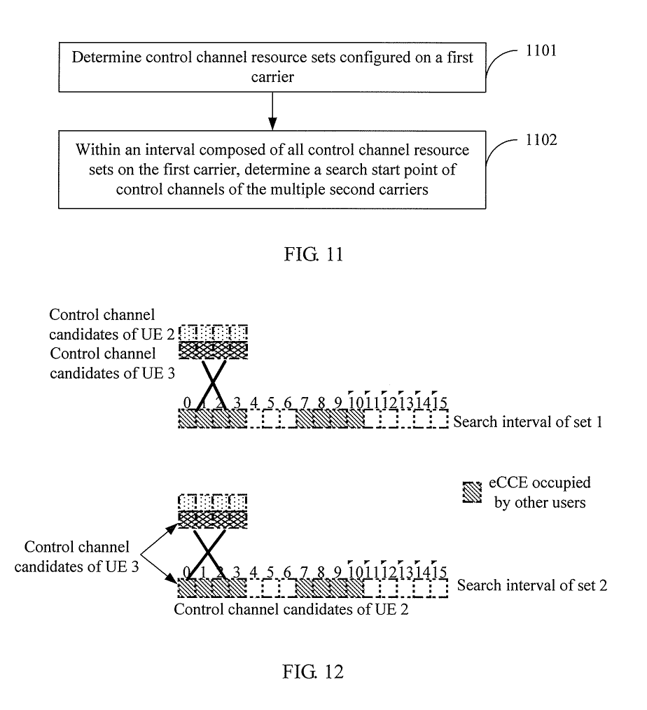

In another embodiment of the present invention, in a multi-carrier scenario, that is, when the UE has configured scheduling of multiple second carriers on a first carrier, the process of determining a search start point of control channels may also be implemented according to the embodiment shown in FIG. 11.

FIG. 11 is a flowchart of a third embodiment of a method for determining a search start point of control channels according to the present invention.

The method may include the following steps:

Step 1101: Determine control channel resource sets configured on a first carrier.

The UE schedules P second carriers on the first carrier CC 0, and control channel resource sets of the P second carriers are configured on the first carrier CC 0. Therefore, first, the UE determines all control channel resource sets on the first carrier CC 0.

Step 1102: Within an interval formed by all control channel resource sets on the first carrier, determine a search start point of control channels of the multiple second carriers.

After all control channel resource sets on the first carrier CC0 are determined, the search start point of control channels of the multiple second carriers may be determined in the following manner.

The search interval of control channels of the N_{CI}th carrier, which are transmitted in the k^{th} subframe of carrier CC 0 and have an aggregation level L, is:

$$L \{ ( {Y}_{k , j} + {m}^{′} ) mod ⌊ {N}_{CCE , k , j} / L ⌋ \} + i , where$$

$${m}^{′} = m + {M}^{( L )} \cdot f ( {n}_{CI} ) . \\ {N}_{CCE , k , j} = {\sum }_{j = 0}^{K ( {n}_{CI} ) - 1} {N}_{CCE , k , j} ,$$

and K(n_{CI}) is the number of control channel resource sets configured for control channels of the n_{CI}th carrier (one of the second carriers) when the control channels are transmitted on the first carrier CC 0, or is the total number of control channel sets configured on the first carrier CC 0, and N_{CCE,k,j} is the number of (e)CCEs in the j^{th} control channel resource set in the k^{th} subframe.

The above expression refers to: within an interval formed by all control channel resource sets on the first carrier, determining the location of a search start point of control channels of each second carrier. In addition, if it is configured that, on the first carrier CC 0, the search interval of control channels of each second carrier is P(n_{CI}) control channel resource sets, and if the number of control channel candidates in each control channel resource set is configured, the start point of the search interval of each second carrier on the first carrier is determined according to the number of eCCEs in all control channel resource sets of the first carrier or the number of (e)CCEs in all sets corresponding to only the second carrier, and according to n_{RNTIi}. For example, the first carrier CC 0 has four control channel resource sets, namely, set 0, set 1, set 2, and set 3, each control channel resource set includes 16 eCCEs, and the control channels of the second carrier CC 1 are transmitted on the first carrier CC 0. Therefore, within a total of 64 eCCEs, the search start point under aggregation level 1 is determined as 18 according to the foregoing formula. In addition, it is configured that two control channel resource sets of the second carrier CC 1 are searched out on the first carrier CC 0, the number of control channel candidates in the first control channel resource set is 4, and the number of control channel candidates in the second control channel resource set is 2. Therefore, 18 corresponds to set 1, the search for the control channels of the second carrier CC 1 starts from set 1, blind detection is performed in set 1 for four times, and blind detection is performed in set 2 twice.

Step 304: Determine a search interval according to a relationship between the search start point, an aggregation level of control channels, and the number of control channel candidates under the aggregation level, where the relationship may be a relational expression.

The aggregation level refers to a minimum granularity of control channels, where the minimum granularity may be an eCCE. The control channels may be transmitted on L eCCEs, where the value of L may be 1, 2, 4, 8, 16, or 32.

The determining a search interval according to a relationship between the search start point, an aggregation level of control channels, and the number of control channel candidates under the aggregation level may specifically be:

determining a search interval according to a relational expression between the search start point, an aggregation level of control channels, and the number of control channel candidates under the aggregation level.

The relational relationship for determining the search interval may be:

The search interval S^{L}ₖ corresponding to the aggregation level L is:

S^{L}k=L{(Yₖ+m′)} mod └N_{CCE,k}/L┘+i

where m′=m+M^{L}·nCI and m=0, . . . M^{(L)}−1. M^{(L)} is the number of control channel candidates under the aggregation level L, and nCI is a parameter related to a multi-carrier aggregation carrier index. N_{CCE,k} is the total number of eCCEs in the search interval at the time point k, where i=0, . . . L−1.

In the foregoing embodiment, as regards how the UE determines the control channel search interval according to the control channel resource set, each UE may determine the search interval in each control channel resource set in the same manner. That is, in each control channel resource set, steps 301 to 304 are performed. In other words, in different control channel resource sets, the initial value of the recursive function for generating the search start point of the control channels may be the same; in different control channel resource sets, the recursive function for determining the search start point is the same; and, in different control channel resource sets, the relational expression for determining the search interval is the same.

However, if multiple UEs determine the search interval in different control channel resource sets by using the same method, conflict may occur. For example, as shown in FIG. 12, if the number of control channel candidates of UE 2 and UE 3 under a specific aggregation level, such as aggregation level 4, in set 1 is 1, and the number in set 2 is also 1, when UE 2 and UE 3 obtains the same search start point, such as eCCE 0 illustrated in FIG. 12, by using the foregoing search start point generation manner, because eCCE 0, eCCE 1, eCCE 2, and eCCE 3 are occupied by other users, the control channel candidates of UE 2 and UE 3 under aggregation level 4 are blocked and cannot be transmitted in set 1, and may still be transmitted in set 2. If UE 2 and UE 3 use the same search start point generation manner as that in set 1, for example, the search start point in set 2 is still eCCE 0, the control channel of either of the two UEs may be put onto eCCE 0, eCCE 1, eCCE 2, and eCCE 3 in set 2. For example, the control channel of UE 2 in FIG. 12 is put in set 2 for transmission. However, because UE 3 and UE 2 have the same search start point and there is only one control channel candidate, the control channel candidate can be put onto only eCCE 0, eCCE 1, eCCE 2, and eCCE 3 for transmission. Because they have been occupied by UE 2, the control channel of UE 3 still cannot be transmitted. Consequently, even if the search interval of set 2 has idle resources, the resources are still unavailable to the control channel of UE 3.

Therefore, when the UE determines the control channel search interval according to the control channel resource set, the manner of determining the search interval in different control channel resource sets may differ. Specifically, the following manner may be applied:

1) In an embodiment of the present invention, in different control channel resource sets, the initial values of recursive functions for generating the search start point of control channels are different. Specifically, the initial value may include a first characteristic parameter, and a different control channel resource set corresponds to a different first characteristic parameter.

Specifically, the first characteristic parameter C(j) may be one of the following:

an index of a first PRB pair among PRB pairs in the control channel resource set; a parameter notified through dynamic signaling or higher-layer signaling; an index of each control channel resource set after all control channel resource sets are numbered; a parameter related to CSI-RS (channel state information-reference signal, channel state information-reference signal) configuration; and an offset value relative to a specified control channel resource set.

The initial value of the search start point Y of control channels in each control channel resource set (the total number of control channel resource sets is k(c)) may specifically be:

Y₋₁=n_{RNTI}≠0

Y₋₁,j=n_{RNTI}+C(j),j=0,1 . . . K(c)−1;

or, Y₋₁,J=n_{RNTI}*C(j),j=0,1 . . . K(c)−1.

If C(j) is an offset value offset (j) relative to a specified control channel resource set, assuming that the specified control channel resource set is a control channel resource set with j=0,

Y₋₁,0=n_{RNTI}, j=0, the search start point of other control channel resource sets is

Y₋₁,j=n_{RNTI}+offset(j),j=1 . . . K(c)−1

or Y₋₁,j=n_{RNTI}*offset(j),j=1 . . . K(c)−1.

offset (j) is an offset value of the j^{th} control channel resource set relative to the 0^{th} control channel resource set. Further, the offset value may be an index value of an index of a first PRB pair in all PRB pairs in each control channel resource set, relative to a first PRB pair in the 0^{th} control channel resource set; or may be a parameter notified through dynamic signaling or higher-layer signaling; or may be an offset value of an index of each control channel resource set relative to the index value of a specific control channel resource set after all control channel resource sets are numbered; or may be a parameter related to CSI-RS configuration.

In addition, if the control channel resource set further includes different control channel types, a different control channel type may also correspond to a different first characteristic parameter.

The different control channel types are attributable to any one of the following groups:

control channels of a normal subframe and control channels of a multimedia broadcast multicast service single-frequency network subframe; semi-statically scheduled control channels and dynamically scheduled control channels; control channels detected in a common search interval and control channels detected in a UE-specific search interval; control channels of uplink scheduling signaling and control channels of downlink scheduling signaling; control channels of centralized transmission and control channels of discrete transmission; control channels of different DCI (Downlink control information, downlink control information); control channels of subframes of different cyclic prefixes; control channels of different special subframe types; control channels transmitted in PRB pairs with different numbers of available REs; control channels transmitted by control channel elements (e)CCEs (enhanced control channel element) that include different numbers of resource element groups (e)REG (enhanced resource element group); and control channels of different carriers.

For example, when each carrier of control channels is configured with K(c) control channel resource sets, the K(c) control channel resource sets include KD(c) control channel resource sets of discrete transmission, and KL(c) control channel resource sets of centralized transmission, and each control channel resource set includes at least one PRB pair. Therefore, in the control channel resource sets, the first characteristic parameter in the control channel resource set of centralized transmission is different from the first characteristic parameter in the control channel resource set of discrete transmission.

2) In another embodiment of the present invention, in different control channel resource sets, the recursive function for determining the search start point is different. Specifically, the recursive function may include a second characteristic parameter, and a different control channel resource set corresponds to a different second characteristic parameter.

Specifically, the second characteristic parameter may be one of the following:

an index of a first PRB pair among PRB pairs in the control channel resource set; a parameter notified through dynamic signaling or higher-layer signaling; an index of each control channel resource set after all control channel resource sets are numbered; a parameter related to CSI-RS configuration; and an offset value relative to a specified control channel resource set.

The recursive function for determining the search start point in the j^{th} control channel resource set (the total number of control channel resource sets is k(c)) may specifically be:

Y_{k,j}=(AY_{k-1,j}+C′(j))mod D,j=0,1 . . . K(c)−1,

or

Y_{k,j}=(A(Y_{k-1,j}+C′(j)))mod D,j=0,1 . . . K(c)−1

or

Y_{k,j}=(AY_{k-1,j}*C′(j))mod D,j=0,1 . . . K(c)−1

or

Y_{k,j}=(C′(j)Y_{k-1,j})mod D,j=0,1 . . . K(c)−1

where C′(j) is the second characteristic parameter.

If the C′(j) is an offset value offset′(j) relative to a specified control channel resource set, assuming that the specified control channel resource set is a control channel resource set with j=0, the recursive function for determining the search start point in the j^{th} control channel resource set may be:

Y_{k,j}=(AY_{k-1,j}+(offset′(j))mod D,j=0,1 . . . K(c)−1,

or

Y_{k,j}=(A(Y_{k-1,j}+offset′(j)))mod D,j=0,1 . . . K(c)−1

or

Y_{k,j}=(AY_{k-1,j}*offset′(j))mod D,j=0,1 . . . K(c)−1

where offset′(j) is an offset value of the j^{th} control channel resource set relative to the 0^{th} control channel resource set. Further, the offset value may be an index value of an index of a first PRB pair in all PRB pairs in each control channel resource set, relative to a first PRB pair in the 0^{th} control channel resource set; or may be a parameter notified through dynamic signaling or higher-layer signaling; or may be an offset value of an index of each control channel resource set relative to the index value of a specific control channel resource set after all control channel resource sets are numbered; or may be a parameter related to CSI-RS configuration.

In addition, if the control channel resource set further includes different control channel types, a different control channel type may also correspond to a different second characteristic parameter.

The different control channel types are attributable to any one of the following groups:

control channels of a normal subframe and control channels of a multimedia broadcast multicast service single-frequency network subframe; semi-statically scheduled control channels and dynamically scheduled control channels; control channels detected in a common search interval and control channels detected in a UE-specific search interval; control channels of uplink scheduling signaling and control channels of downlink scheduling signaling; control channels of centralized transmission and control channels of discrete transmission; control channels of different DCI; control channels of subframes of different cyclic prefixes; control channels of different special subframe types; control channels transmitted in physical resource pairs (PRB pairs) with different numbers of available resource elements (REs); control channels transmitted by control channel elements that include different numbers of resource element groups; and control channels of different carriers.

For example, when each carrier of control channels is configured with K(c) control channel resource sets, the K(c) control channel resource sets include KD(c) control channel resource sets of discrete transmission, and KL(c) control channel resource sets of centralized transmission, and each control channel resource set includes at least one PRB pair. Therefore, in the control channel resource sets, the second characteristic parameter in the control channel resource set of centralized transmission is different from the second characteristic parameter in the control channel resource set of discrete transmission.

3) In another embodiment of the present invention, in different control channel resource sets, the relational expression for determining the search interval is different. Specifically, the relational expression for determining the search interval may include a third characteristic parameter, and a different control channel resource set corresponds to a different third characteristic parameter.

Specifically, the third characteristic parameter may be one of the following:

an index of a first PRB pair among PRB pairs in the control channel resource set; a parameter notified through dynamic signaling or higher-layer signaling; an index of each control channel resource set after all control channel resource sets are numbered; a parameter related to CSI-RS configuration; and an offset value relative to a specified control channel resource set.

The search interval of the j^{th} control channel resource set under the aggregation level L is

L{(Y_{k,j}+m′)mod └N_{CCE,k,j}/L┘}+i,m′=m+Mⱼ^{(L)}·n_{CI}+C″(j)

where C″(j) is the third characteristic parameter, N_{CCE,k,j} is the number of eCCEs in the j^{th} control channel resource set, and Mⱼ^{(L)} is the number of control channel candidates under the aggregation level L in the j^{th} control channel resource set.

If C″(j) is an offset value offset″(j) relative to a specified control channel resource set, assuming that the selected control channel resource set is a control channel resource set with j=0, the relational expression for generating the search interval may be:

L{(Y_{k,j}+m′)mod └N_{CCE,k}/L┘}+i,m′=m+M^{(L)}·n_{CI}+offset″(j).

offset″(j) is an offset value of the j^{th} control channel resource set relative to the 0^{th} control channel resource set. Further, the offset value may be an index value of an index of a first PRB pair in all PRB pairs in each control channel resource set, relative to a first PRB pair in the 0^{th} control channel resource set; or may be a parameter notified through dynamic signaling or higher-layer signaling; or may be an offset value of an index of each control channel resource set relative to the index value of a specific control channel resource set after all control channel resource sets are numbered; or may be a parameter related to CSI-RS configuration.

In addition, if the control channel resource set further includes different control channel types, a different control channel type may also correspond to a different third characteristic parameter.

The different control channel types are attributable to any one of the following groups:

control channels of a normal subframe and control channels of a multimedia broadcast multicast service single-frequency network subframe; semi-statically scheduled control channels and dynamically scheduled control channels; control channels detected in a common search interval and control channels detected in a UE-specific search interval; control channels of uplink scheduling signaling and control channels of downlink scheduling signaling; control channels of centralized transmission and control channels of discrete transmission; control channels of different DCI; control channels of subframes of different cyclic prefixes; control channels of different special subframe types; control channels transmitted in physical resource pairs (PRB pairs) with different numbers of available resource elements (REs); control channels transmitted by control channel elements that include different numbers of resource element groups; and control channels of different carriers.

For example, when each carrier of control channels is configured with K(c) control channel resource sets, the K(c) control channel resource sets include KD(c) control channel resource sets of discrete transmission, and KL(c) control channel resource sets of centralized transmission, and each control channel resource set includes at least one PRB pair. Therefore, in the control channel resource sets, the third characteristic parameter in the control channel resource set of centralized transmission is different from the third characteristic parameter in the control channel resource set of discrete transmission.

To make the search interval determining manner vary in different control channel resource sets, 1), 2) and 3) may be applied in the same embodiment. The foregoing embodiment can reduce the probability of control channel conflict between the UEs and improve transmission efficiency.

The above text has described the manner of determining the search interval in different control channel resource sets when the UE determines the control channel search interval according to the control channel resource set. When the UE determines the control channel search interval according to the control channel type, the UE may determine the control channel search interval in different control channel types in the same manner, that is, steps 301 to 304 are performed for all the different control channel types. However, to avoid conflict, in different control channel types, the UE may determine the control channel search interval in different manners detailed below:

1) In an embodiment of the present invention, in different control channel types, the manner of determining a control channel set that includes the control channel search interval is different.

The determining a control channel set that includes the control channel search interval may specifically be:

in N control channel resource sets configured by a higher layer, determining, according to the subframe number, the control channel resource sets that respectively include the control channel search interval of different control channel types of a current subframe, the control channel resource sets that respectively include the control channel search interval of different control channel types in different subframes are the same or different.

As shown in FIG. 4b, set 0 and set 1 are control channel resource sets configured by the higher layer. Within subframe 0, set is a centralized transmission set and set 1 is a discrete transmission set, and therefore, in a next subframe, namely, subframe 1, set 0 is a discrete transmission set and set 1 is a centralized transmission set.

2) In another embodiment of the present invention, in different control channel types, the manner of determining the number of control channel candidates in each control channel set that includes the control channel search interval is different.

Specifically, the number of control channel candidates of the control channel search interval in each control channel set may be determined according to a carrier ID and/or a radio network temporary identifier and/or a subframe number.

For example, as shown in FIG. 4c, set 0 and set 1 are control channel resource sets configured by the higher layer. Within subframe 0, the number of control channel candidates configured in set 0 is M, and the number of control channel candidates configured in set 1 is N, and therefore, within a next subframe, namely, subframe 1, the number of control channel candidates configured in set 0 is N, and the number of control channel candidates configured in set 1 is M; or, within a next subframe, namely, subframe 1, the number of control channel candidates configured in set 0 is X, and the number of control channel candidates configured in set 1 is Y, where X is unequal to N, and Y is unequal to M.

3) In another embodiment of the present invention, in different control channel types, the initial values of recursive functions for generating the search start point of control channels are different. Specifically, the initial value may include a fourth characteristic parameter, and a different control channel type corresponds to a different fourth characteristic parameter.

The different control channel types are attributable to any one of the following groups:

control channels of a normal subframe and control channels of a multimedia broadcast multicast service single-frequency network subframe; semi-statically scheduled control channels and dynamically scheduled control channels; control channels detected in a common search interval and control channels detected in a UE-specific search interval; control channels of uplink scheduling signaling and control channels of downlink scheduling signaling; control channels of centralized transmission and control channels of discrete transmission; control channels of different DCI; control channels of subframes of different cyclic prefixes; control channels of different special subframe types; control channels transmitted in physical resource pairs (PRB pairs) with different numbers of available resource elements (REs); control channels transmitted by control channel elements that include different numbers of resource element groups; and control channels of different carriers.

4) In another embodiment of the present invention, in different control channel types, the recursive function for determining the search start point is different. Specifically, the recursive function for determining the search start point may include a fifth characteristic parameter, and a different control channel type corresponds to a different fifth characteristic parameter.

The different control channel types are attributable to any one of the following groups:

control channels of a normal subframe and control channels of a multimedia broadcast multicast service single-frequency network subframe; semi-statically scheduled control channels and dynamically scheduled control channels; control channels detected in a common search interval and control channels detected in a UE-specific search interval; control channels of uplink scheduling signaling and control channels of downlink scheduling signaling; control channels of centralized transmission and control channels of discrete transmission; control channels of different DCI; control channels of subframes of different cyclic prefixes; control channels of different special subframe types; control channels transmitted in physical resource pairs (PRB pairs) with different numbers of available resource elements (REs); control channels transmitted by control channel elements that include different numbers of resource element groups; and control channels of different carriers.

5) In another embodiment of the present invention, in different control channel types, the relational expression for determining the search interval is different. Specifically, the relational expression for determining the search interval may include a sixth characteristic parameter, and a different control channel type corresponds to a different sixth characteristic parameter.

The different control channel types are attributable to any one of the following groups:

control channels of a normal subframe and control channels of a multimedia broadcast multicast service single-frequency network subframe; semi-statically scheduled control channels and dynamically scheduled control channels; control channels detected in a common search interval and control channels detected in a UE-specific search interval; control channels of uplink scheduling signaling and control channels of downlink scheduling signaling; control channels of centralized transmission and control channels of discrete transmission; control channels of different DCI; control channels of subframes of different cyclic prefixes; control channels of different special subframe types; control channels transmitted in PRB pairs with different numbers of available REs; control channels transmitted by control channel elements (e)CCE that include different numbers of resource element groups (e)REG; and control channels of different carriers.

To make the search interval determining manner vary in different control channel types, 1) to 5) above may be applied in the same embodiment. The foregoing embodiment can reduce the probability of control channel conflict between the UEs and improve transmission efficiency.

The foregoing embodiment deals with a scenario in which the granularity of the control channel search interval determined by the UE is a search interval within a control channel resource set. In another embodiment of the present invention, when the control channel type is attributable to control channels of different carriers, the control channel search interval determined by the UE is control channel resource sets, that is, the granularity of the control channel search interval determined by the UE is control channel resource sets. In this case, the process of the UE determining the control channel search interval according to the control channel type may specifically include:

when the UE has configured scheduling of multiple second carriers on a first carrier, determining a control channel resource set corresponding to the user equipment according to a mapping relationship between the second carrier and the control channel resource set.

The mapping relationship between the second carrier and the control channel resource set may be as follows:

the control channel resource set of the second carrier is a function of an index number of the second carrier; or

a location of the control channel resource set on the first carrier is the same as a location of the control channel resource set on the second carrier.

The mapping relationship between the second carrier and the control channel resource set here is similar to the mapping relationship described in step 301 between the second carrier and the control channel resource set. That the control channel resource set of the second carrier is a function of the index number of the second carrier specifically may also be: as shown in FIG. 5, P second carriers are scheduled on the first carrier CC 0, and, on the first carrier CC 0, the control channel resource set of the control channels of the P second carriers is a function of the index number of the P second carriers.

For example, four control channel resource sets, namely, set 0, set 1, set 2, and set 3, are configured on the first carrier CC 0. In practical transmission, the PRB pairs in each control channel resource set may be discontinuous and discrete. For ease of illustration, the PRB pairs in each control channel resource set in

FIG. 5 are continuous. Assuming that n_{CI} is a sequence number index of each second carrier, the control channel resource set of the control channels of the P second carriers within the search interval on the first carrier CC 0 is a function of n_{CI}. In FIG. 5, it is obtained, according to the function relationship, that, the sequence number index of the second carrier CC 1 corresponds to set 3 and set 0, the sequence number index of the second carrier CC 2 corresponds to set 2 and set 3, the sequence number index of the second carrier CC 3 corresponds to set 1 and set 2, and the sequence number index of the second carrier CC 4 corresponds to set 0 and set 1. Therefore, correspondingly, the control channels of the second carrier CC 1 are detected on set 3 and set 0 on the first carrier CC 0, the control channels of the second carrier CC 2 are detected on set 2 and set 3 on the first carrier CC 0, the control channels of the second carrier CC 3 are detected on set 1 and set 2 on the first carrier CC 0, and the control channels of the second carrier CC 4 are detected on set 0 and set 1 on the first carrier CC 0.

That the location of the control channel resource set on the first carrier is the same as the location of the control channel resource set on the second carrier specifically may be: as shown in FIG. 6, if set 1 is configured on the second carrier CC 1, set 2 is configured on the second carrier CC 2, and set 3 is configured on the second carrier CC 3, when the control channel of the second carrier CC 1 is detected on the first carrier CC 0, the detection is performed in the location existing on the first carrier CC 0 and corresponding to set 1 configured on the second carrier CC 1; when the control channel of the second carrier CC 2 is detected on the first carrier CC 0, the detection is performed in the location existing on the first carrier CC 0 and corresponding to set 2 configured on the second carrier CC 2; and, when the control channel of the second carrier CC 3 is detected on the first carrier CC 0, the detection is performed in the location existing on the first carrier CC 0 and corresponding to set 3 configured on the second carrier CC 3.

Described above is a method embodiment of performing control channel detection on the UE side. On the base station side, the method for a base station to configure control channels is as follows:

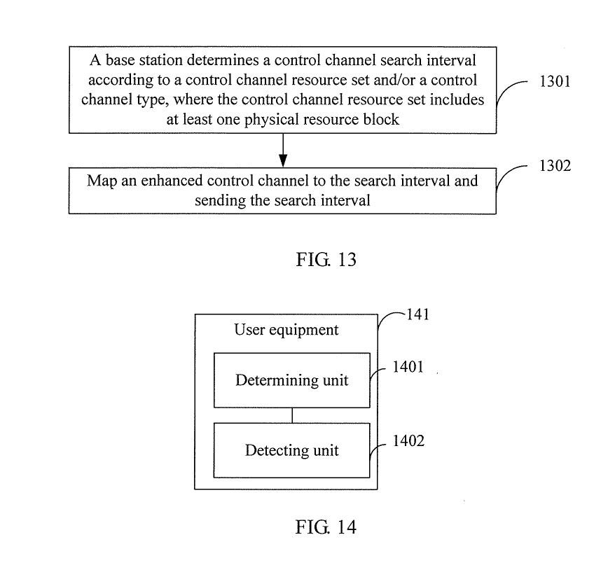

FIG. 13 is a flowchart of a control channel transmission method according to an embodiment of the present invention.

The method may include the following steps:

Step 1301: The base station determines a control channel search interval according to a control channel resource set and/or a control channel type, where the control channel resource set includes at least one physical resource block.

This step exactly corresponds to the process of determining a control channel search interval according to a control channel resource set and/or a control channel type on the UE side. For details, reference may be made to the corresponding description about the UE side, and no repeated description is given here any further.

Step 1302: Map an enhanced control channel to the search interval and send the search interval.

Described above is a method embodiment of the present invention. The following introduces an apparatus for implementing the method.

FIG. 14 is a schematic structural diagram of a first embodiment of a user equipment according to the present invention.

The user equipment 141 may include:

a determining unit 1401, configured to determine a control channel search interval according to a control channel resource set and/or a control channel type, where the control, channel resource set includes at least one physical resource block; and

a detecting unit 1402, configured to perform control channel detection in the search interval determined by the determining unit 1401.

In the embodiment of the present invention, the UE can determine an E-PDCCH search interval according to the control channel resource set and/or the control channel type by using the foregoing units, thereby implementing control channel detection of the UE. In this way, a solution is provided for the scenario in which multiple control channel resource sets are configured by a network side for the UE.

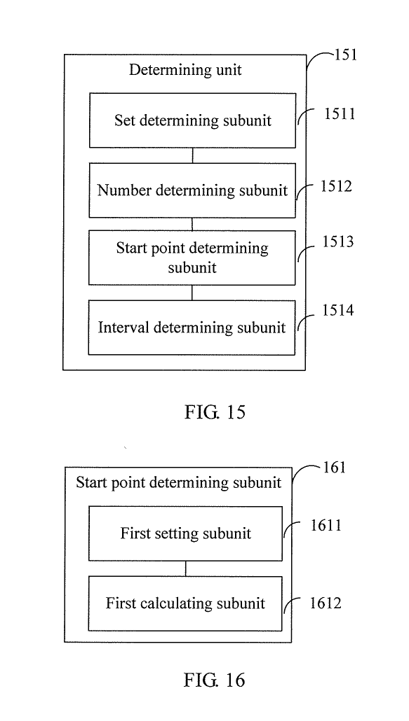

FIG. 15 is a schematic structural diagram of a determining unit according to an embodiment of the present invention.

The determining unit 151 in the user equipment may further include:

a set determining subunit 1511, configured to determine a control channel set that includes the control channel search interval;

a number determining subunit 1512, configured to determine the number of control channel candidates of the control channel search interval in each control channel set;

a start point determining subunit 1513, configured to determine a search start point of control channels; and

an interval determining subunit 1514, configured to determine a search interval according to a relationship between the search start point determined by the start point determining subunit, an aggregation level of control channels, and the number of control channel candidates under the aggregation level.

The set determining subunit 1511 may be specifically configured to: determine a control channel resource set that includes a control channel search interval according to a carrier and/or a radio network temporary identifier and/or a subframe number; and may be further configured to: when the user equipment has configured scheduling of multiple second carriers on a first carrier, determine, according to a mapping relationship between the second carrier and the control channel resource set, a control channel resource set existing on the first carrier and corresponding to a control channel of the second carrier.

The number determining subunit 1512 may be specifically configured to determine the number of control channel candidates of the control channel search interval in each control channel set according to a carrier index ID and/or a radio network temporary identifier and/or a subframe number.

FIG. 16 is a schematic structural diagram of a first embodiment of a start point determining subunit according to the present invention.

Further, the start point determining subunit 161 in the determining unit may specifically include:

a first setting subunit 1611, configured to determine an initial value of the search start point of each control channel resource set in a first subframe; and

a first calculating subunit 1612, configured to obtain the search start point of control channels in a first control channel resource set by using a recursive function according to the search start point of control channels in a second control channel resource set, where

a subframe that includes the second control channel resource set is a subframe previous to the subframe that includes the first control channel resource set, and the first control channel resource set and the second control channel resource set are in the same location in their respective subframes.

In another embodiment, the start point determining subunit may also include:

a second setting subunit, configured to determine an initial value of the search start point of a first control channel resource set in a first subframe; and

a second calculating subunit, configured to obtain the search start point of control channels in a third control channel resource set by using a recursive function according to the search start point of control channels in a fourth control channel resource set, where

the third control channel resource set and the fourth control channel resource set are located in the same subframe, and, in the same subframe, the order of location of the fourth control channel resource set is previous and adjacent to that of the third control channel resource set; or, the fourth control channel resource set is in a subframe previous to the subframe that includes the third control channel resource set, the fourth control channel resource set is the last set in the subframe that includes the fourth control channel resource set, and the third control channel resource set is the first set in the subframe that includes the third control channel resource set.

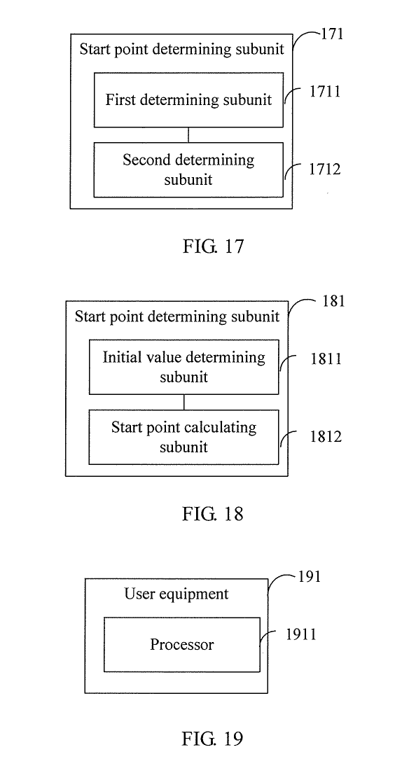

FIG. 17 is a schematic structural diagram of a second embodiment of a start point determining subunit according to the present invention.

Further, the start point determining subunit 171 in the determining unit may specifically include:

a first determining subunit 1711, configured to: when scheduling of multiple second carriers on a first carrier is configured, determine control channel resource sets configured on the first carrier; and

a second determining subunit 1712, configured to: within an interval formed by all control channel resource sets on the first carrier, determine a search start point of control channels of the multiple second carriers.

FIG. 18 is a schematic structural diagram of a third embodiment of a start point determining subunit according to the present invention.

Further, the start point determining subunit 181 in the determining unit may specifically include:

an initial value determining subunit 1811, configured to determine an initial value of the recursive function for generating the search start point of control channels; and

a start point calculating subunit 1812, configured to determine the search start point according to the initial value of the recursive function of the search start point and the recursive function.

FIG. 19 is a schematic structural diagram of a second embodiment of a user equipment according to the present invention.

The user equipment 191 includes a processor 1911:

the processor 1911 is configured to determine a control channel search interval according to a control channel resource set and/or a control channel type, where the control channel resource set includes at least one physical resource block; and perform control channel detection in the determined search interval.

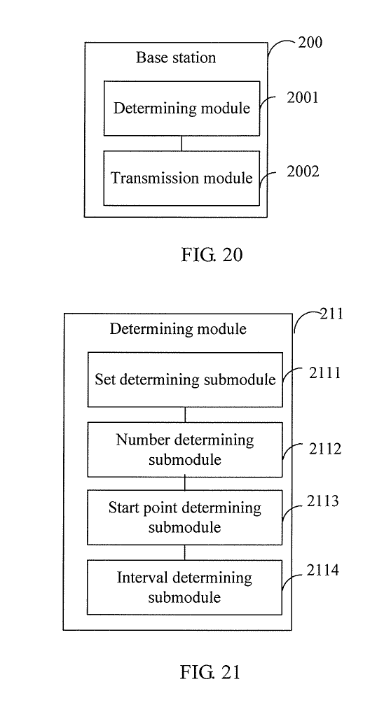

FIG. 20 is a schematic structural diagram of a first embodiment of a base station according to the present invention.

The base station 200 may include:

a determining module 2001, configured to determine a control channel search interval according to a control channel resource set and/or a control channel type, where the control channel resource set includes at least one physical resource block; and

a transmission module 2002, configured to map an enhanced control channel to the search interval determined by the determining module and send the search interval.

FIG. 21 is a schematic structural diagram of a determining module according to an embodiment of the present invention.

The determining module 211 may include:

a set determining submodule 2111, configured to determine a control channel set that includes the control channel search interval;

a number determining submodule 2112, configured to determine the number of control channel candidates of the control channel search interval in each control channel set;

a start point determining submodule 2113, configured to determine a search start point of control channels; and

an interval determining submodule 2114, configured to determine a search interval according to a relationship between the search start point determined by the start point determining submodule, an aggregation level of control channels, and the number of control channel candidates under the aggregation level.

The set determining submodule 2111 may be specifically configured to: determine a control channel resource set that includes a control channel search interval according to a carrier and/or a radio network temporary identifier and/or a subframe number; and may be further configured to: when scheduling of multiple second carriers on a first carrier is configured, determine, according to a mapping relationship between the second carrier and the control channel resource set, a control channel resource set existing on the first carrier and corresponding to a control channel of the second carrier.

The number determining submodule 2112 may be specifically configured to determine the number of control channel candidates of the control channel search interval in each control channel set according to a carrier ID and/or a radio network temporary identifier and/or a subframe number.

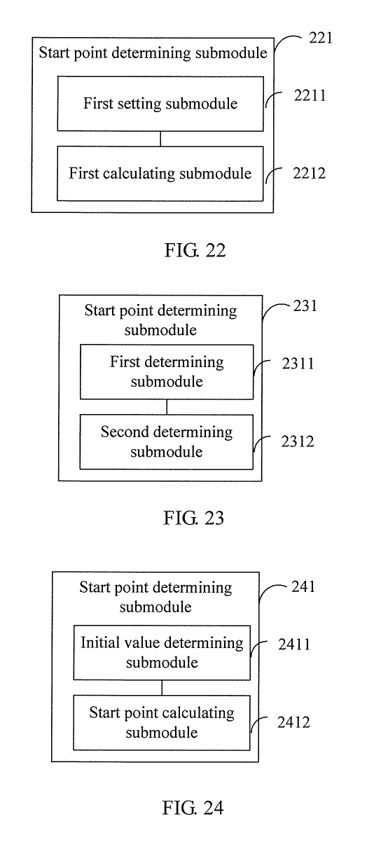

FIG. 22 is a schematic structural diagram of a first embodiment of a start point determining submodule according to the present invention.

Further, the start point determining submodule 221 in the determining module may include:

a first setting submodule 2211, configured to determine an initial value of the search start point of each control channel resource set in a first subframe; and

a first calculating submodule 2212, configured to obtain the search start point of control channels in a first control channel resource set by using a recursive function according to the search start point of control channels in a second control channel resource set, where

a subframe that includes the second control channel resource set is a subframe previous to the subframe that includes the first control channel resource set, and the first control channel resource set and the second control channel resource set are in the same location in their respective subframes.

In another embodiment, the start point determining submodule may also include:

a second setting submodule, configured to determine an initial value of the search start point of a first control channel resource set in a first subframe; and

a second calculating submodule, configured to obtain the search start point of control channels in a third control channel resource set by using a recursive function according to the search start point of control channels in a fourth control channel resource set, where

the third control channel resource set and the fourth control channel resource set are located in the same subframe, and, in the same subframe, the order of location of the fourth control channel resource set is previous and adjacent to that of the third control channel resource set; or, the fourth control channel resource set is in a subframe previous to the subframe that includes the third control channel resource set, the fourth control channel resource set is the last set in the subframe that includes the fourth control channel resource set, and the third control channel resource set is the first set in the subframe that includes the third control channel resource set.

FIG. 23 is a schematic structural diagram of a second embodiment of a start point determining submodule according to the present invention.

Further, the start point determining submodule 231 in the determining module may include:

a first determining submodule 2311, configured to: when scheduling of multiple second carriers on a first carrier is configured, determine control channel resource sets configured on the first carrier; and

a second determining submodule 2312, configured to: within an interval formed by all control channel resource sets on the first carrier, determine a search start point of control channels of the multiple second carriers.

FIG. 24 is a schematic structural diagram of a third embodiment of a start point determining submodule according to the present invention.

Further, the start point determining submodule 241 in the determining module may include:

an initial value determining submodule 2411, configured to determine an initial value of the recursive function for generating the search start point of control channels; and

a start point calculating submodule 2412, configured to determine the search start point according to the initial value of the recursive function of the search start point and the recursive function.

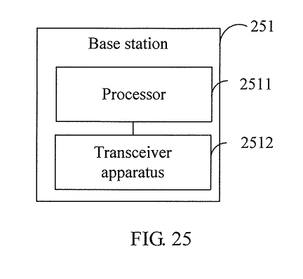

FIG. 25 is a schematic structural diagram of a second embodiment of a base station according to the present invention.

The base station 251 may include a processor 2511 and a transceiver apparatus 2512.

The processor 2511 is configured to determine a control channel search interval according to a control channel resource set and/or a control channel type, where the control channel resource set includes at least one physical resource block; and map an enhanced control channel to the determined search interval.

The transceiver apparatus 2512 is configured to send the search interval.

For the detailed implementation process of units and modules in the apparatus, reference may be made to the corresponding description in the method embodiment, and no repeated description is given here any further. The transceiver apparatus may be a transceiver.

A person of ordinary skill in the art may be aware that, with reference to the examples described in the embodiments disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to the corresponding process in the foregoing method embodiments, and the details will not be described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of the present invention essentially, or the part contributing to the prior art, or all or a part of the technical solutions may be implemented in a form of a software product. The computer software product is stored in a storage medium, and includes several instructions for instructing a computer device (which may be a personal computer, a server, or a network device or the like) or a processor (processor) to perform all or a part of the steps of the methods described in the embodiments of the present invention. The foregoing storage medium includes: any mediums capable of storing program code, such as a USB flash drive, a removable hard disk, a read-only memory (ROM, Read-Only Memory), a random access memory (RAM, Random Access Memory), a magnetic disk, or an optical disc.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A control channel detection method, comprising:
determining, by a user equipment, a control channel search interval according to a control channel resource set and/or a control channel type, wherein the control channel resource set comprises at least one physical resource block, wherein the determining a control channel search interval comprises:
determining a control channel set that comprises the control channel search interval,
determining the number of control channel candidates of the control channel search interval in each control channel set,
determining a search start point of control channels, and
determining a search interval according to a relationship between the search start point, an aggregation level of control channels, and the number of control channel candidates under the aggregation level; and
performing control channel detection in the search interval.

2. The method according to claim 1, wherein determining a control channel set that comprises the control channel search interval comprises:
determining a control channel resource set that comprises the control channel search interval according to a carrier and/or a radio network temporary identifier and/or a subframe number.

3. The method according to claim 1, wherein determining a search start point of control channels comprises:
determining an initial value of a recursive function for generating the search start point of control channels; and
determining the search start point according to the initial value of the recursive function of the search start point and the recursive function.

4. The method according to claim 3, wherein, in different control channel resource sets, initial values of recursive functions for generating the search start point of control channels are the same.

5. The method according to claim 3, wherein, in different control channel resource sets, the recursive function for determining the search start point is the same.

6. The method according to claim 3, wherein, in different control channel resource sets, the recursive function for determining the search start point is different.

7. The method according to claim 6, wherein the recursive function comprises a second characteristic parameter, and a different control channel resource set corresponds to a different second characteristic parameter.

8. The method according to claim 7, wherein the recursive function for determining the search start point in the j^{th} control channel resource set is:
Y_{k,j}=(C′(j)Y_{k-1,j})mod D,j=0,1 . . . K(c)−1
where k(c) is the total number of control channel resource sets, C′(j) is the second characteristic parameter.

9. The method according to claim 7, wherein the second characteristic parameter is one of the following:
an index of a first PRB pair among PRB pairs in the control channel resource set;
a parameter notified through dynamic signaling or higher-layer signaling;
a sequence number index of a physical resource block set; and
an offset value relative to a specified control channel resource set.

10. The method according to claim 1, wherein, indifferent control channel types, the control channel set that comprises the control channel search interval is determined in different manners.

11. The method according to claim 10, wherein, in different control channel types, the number of control channel candidates of the control channel search interval in each control channel set is determined in different manners.

12. The method according to claim 10, wherein different control channel types are attributable to any one of the following groups:
control channels of a normal subframe and control channels of a multimedia broadcast multicast service single-frequency network subframe;
semi-statically scheduled control channels and dynamically scheduled control channels; control channels detected in a common search interval and control channels detected in a UE-specific search interval; control channels of uplink scheduling signaling and control channels of downlink scheduling signaling;
control channels of centralized transmission and control channels of discrete transmission; control channels of different DCI;
control channels of subframes of different cyclic prefixes;
control channels of different special subframe types;
control channels transmitted in physical resource pairs (PRB pairs) with different numbers of available resource elements (REs);
control channels transmitted by control channel elements that comprise different numbers of resource element groups; and
control channels of different carriers.

13. A control channel transmission method, comprising:
determining, by a base station, a control channel search interval according to a control channel resource set and/or a control channel type, wherein the control channel resource set comprises at least one physical resource block, and wherein determining a control channel search interval comprises:
determining a control channel set that comprises the control channel search interval,
determining the number of control channel candidates of the control channel search interval in each control channel set,
determining a search start point of control channels, and
determining a search interval according to a relationship between the search start point, an aggregation level of control channels, and the number of control channel candidates under the aggregation level; and
mapping an enhanced control channel to the search interval and sending the search interval;

14. The method according to claim 13, wherein determining a control channel set that comprises the control channel search interval comprises:
determining a control channel resource set that comprises the control channel search interval according to a carrier and/or a radio network temporary identifier and/or a subframe number.

15. The method according to claim 13, wherein determining a search start point of control channels comprises:
determining an initial value of a recursive function for generating the search start point of control channels; and
determining the search start point according to the initial value of the recursive function of the search start point and the recursive function.

16. The method according to claim 15, wherein, in different control channel resource sets, initial values of recursive functions for generating the search start point of control channels are the same.

17. The method according to claim 15, wherein, in different control channel resource sets, the recursive function for determining the search start point is the same.

18. The method according to claim 15, wherein, in different control channel resource sets, the recursive function for determining the search start point is different.

19. The method according to claim 18, wherein the recursive function comprises a second characteristic parameter, and a different control channel resource set corresponds to a different second characteristic parameter.

20. The method according to claim 19, wherein the recursive function for determining the search start point in the j^{th} control channel resource set is:
Y_{k,j}=(C′(j)Y_{k-1,j})mod D,j=0,1 . . . K(c)−1
where k(c) is the total number of control channel resource sets, C′(j) is the second characteristic parameter.

21. The method according to claim 19, wherein the second characteristic parameter is one of the following:
an index of a first PRB pair among PRB pairs in the control channel resource set;
a parameter notified through dynamic signaling or higher-layer signaling; a sequence number index of a physical resource block set; and
an offset value relative to a specified control channel resource set.

22. The method according to claim 13, wherein, in different control channel types, the control channel set that comprises the control channel search interval is determined in different manners.

23. The method according to claim 13, wherein, in different control channel types, the number of control channel candidates of the control channel search interval in each control channel set is determined in different manners.

24. The method according to claim 22, wherein different control channel types are attributable to any one of the following groups:
control channels of a normal subframe and control channels of a multimedia broadcast multicast service single-frequency network subframe;
semi-statically scheduled control channels and dynamically scheduled control channels;
control channels detected in a common search interval and control channels detected in a UE-specific search interval;
control channels of uplink scheduling signaling and control channels of downlink scheduling signaling;
control channels of centralized transmission and control channels of discrete transmission; control channels of different DCI;
control channels of subframes of different cyclic prefixes;
control channels of different special subframe types;
control channels transmitted in physical resource pairs (PRB pairs) with different numbers of available resource elements (REs);
control channels transmitted by control channel elements that comprise different numbers of resource element groups; and
control channels of different carriers.

25. A user equipment, comprising:
a determining unit, configured to determine a control channel search interval according to a control channel resource set and/or a control channel type, wherein the control channel resource set comprises at least one physical resource block, and wherein the determining unit comprises:
a set determining subunit, configured to determine a control channel set that comprises the control channel search interval,
a number determining subunit, configured to determine the number of control channel candidates of the control channel search interval in each control channel set,
a start point determining subunit, configured to determine a search start point of control channels, and
an interval determining subunit, configured to determine a search interval according to a relationship between the search start point determined by the start point determining subunit, an aggregation level of control channels, and the number of control channel candidates under the aggregation level; and
a detecting unit, configured to perform control channel detection in the search interval determined by the determining unit.

26. The user equipment according to claim 25, wherein the set determining subunit is configured to determine a control channel resource set that comprises the control channel search interval according to a carrier and/or a radio network temporary identifier and/or a subframe number.

27. The user equipment according to claim 25, wherein the start point determining subunit comprises:
an initial value determining subunit, configured to determine an initial value of the recursive function for generating the search start point of control channels; and
a start point calculating subunit, configured to determine the search start point according to the initial value of the recursive function of the search start point and the recursive function.

28. A base station, comprising:
a determining module, configured to determine a control channel search interval according to a control channel resource set and/or a control channel type, wherein the control channel resource set comprises at least one physical resource block, and wherein the determining module comprises:
a set determining submodule, configured to determine a control channel set that comprises the control channel search interval,
a number determining submodule, configured to determine the number of control channel candidates of the control channel search interval in each control channel set,
a start point determining submodule, configured to determine a search start point of control channels, and
an interval determining submodule, configured to determine a search interval according to a relationship between the search start point determined by the start point determining submodule, an aggregation level of control channels, and the number of control channel candidates under the aggregation level; and
a transmission module, configured to map an enhanced control channel to the search interval determined by the determining module and send the search interval.

29. The base station according to claim 28, wherein the set determining submodule is configured to determine a control channel resource set that comprises the control channel search interval according to a carrier and/or a radio network temporary identifier and/or a subframe number.

30. The base station according to claim 28, wherein the start point determining submodule comprises:
an initial value determining submodule, configured to determine an initial value of the recursive function for generating the search start point of control channels; and
a start point calculating submodule, configured to determine the search start point according to the initial value of the recursive function of the search start point and the recursive function.
